(19) United States
(12) Patent Application Publication
(10) Pub. No.: US 2013/0301294 A1
(43) Pub. Date: Nov. 14, 2013

(54) LIGHT GUIDE MEMBER, BACKLIGHT MODULE AND METHOD FOR MAKING LIGHT GUIDE MEMBER

(71) Applicant: HON HAI PRECISION INDUSTRY CO., LTD., Tu-Cheng (TW)

(72) Inventor: CHIH-CHEN LAI, Tu-Cheng (TW)

(73) Assignee: HON HAI PRECISION INDUSTRY CO., LTD., Tu-Cheng (TW)

(21) Appl. No.: 13/625,899

(22) Filed: Sep. 25, 2012

(30) Foreign Application Priority Data
May 10, 2012 (TW) 101116642

(51) Int. Cl. F21V 7/04; B29D 11/00; F21V 8/00

(52) U.S. Cl. 362/609; 362/621; 362/608; 264/1.24

(57) ABSTRACT

A light guide member includes an optical fiber layer and a light diffusion layer formed on the optical fiber layer. The optical fiber layer has a light incident side surface, the optical fibers are parallel with each other, and ends of the optical fibers are exposed to the light incident side surface. The light diffusion layer has a number of light scattering particles dispersed therein. The light diffusion layer has a light output top surface, and the light output top surface has a number of netted dots configured for diffusing light. Light enters the optical fibers and transmits through a wall of the optical fibers to reach at the light diffusion layer and finally output from the light output top surface of the light diffusion layer. A backlight module and a method for making the light guide member are also provided.

### BACKGROUND

1. Technical Field

The present disclosure relates to light guide members, and particularly to a light guide member having integrated functions of light guide plate and light diffusion plate, a backlight module using same and a method for making the light guide members.

2. Description of Related Art

Light guide plates and light diffusion plates are key components of backlight modules. Conventional light guide plates are formed by injection molding. An assembly of the conventional light guide plate and the light diffusion plate makes the assembly larger in size.

What is needed, therefore, is a light guide member, a backlight module using same and a method for making the light guide members, which can overcome the above shortcomings.

### BRIEF DESCRIPTION OF THE DRAWINGS

Many aspects of the present light guide member, backlight module and method can be better understood with reference to the following drawings. The components in the drawings are not necessarily drawn to scale, the emphasis instead being placed upon clearly illustrating the principles of the present light guide member, backlight module and method. Moreover, in the drawings, like reference numerals designate corresponding parts throughout the several views.

FIG. 1 is a schematic isometric view of a light guide member in accordance with an embodiment.

FIG. 2 is a schematic view of a backlight module using the light guide member of FIG. 1.

FIGS. 3 to 7 show steps for making the light guide member of FIG. 1.

### DETAILED DESCRIPTION

Embodiments of the present light guide member, backlight module and method will now be described in detail below and with reference to the drawings.

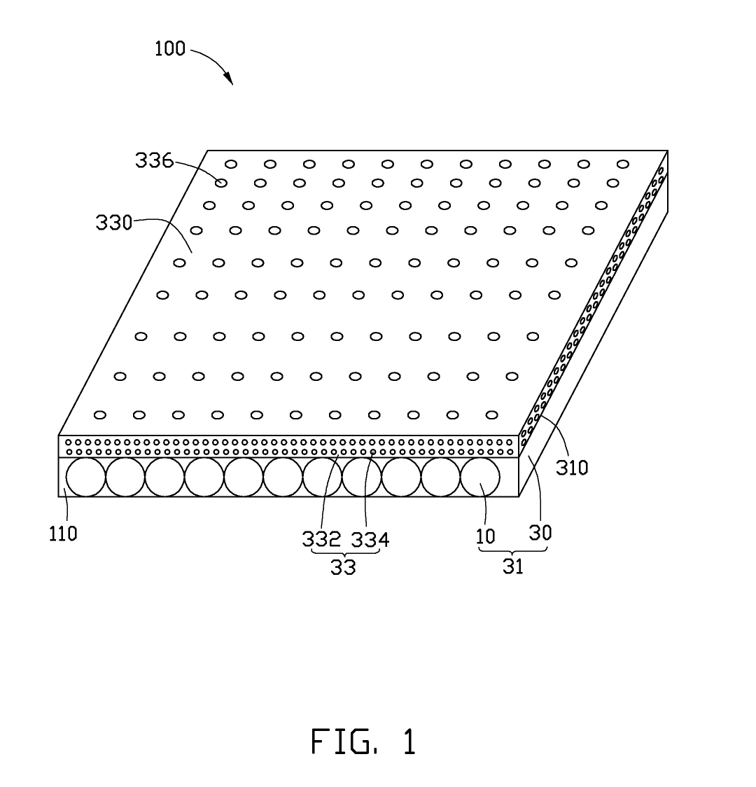

Referring to FIG. 1, a light guide member 100 includes an optical fiber layer 31 and a light diffusion layer 33 formed on the optical fiber layer 31.

The optical fiber layer 31 includes a transparent matrix 30 and a number of optical fibers 10 arranged parallel to each other and adhered in position by the matrix 30. Distal ends of the optical fibers 10 are exposed at a light incident side surface 110 of the optical fiber layer 31, and a top wall of each of the optical fibers 10 can be exposed to the light diffusion layer 33. The optical fibers 10 can be made of plastic or glass. The light incident side surface 110 serves as a light incident surface for the light guide member 100. The optical fiber layer 31 has a top surface 310 facing the light diffusion layer 33.

The light diffusion layer 33 is formed on the top surface 310 of the optical fiber layer 31. The light diffusion layer 33 includes a transparent matrix 332 and a plurality of light scattering particles 334 dispersed in the matrix 332. The matrix 332 can be the same as the matrix 30, and each of the matrix 332 and the matrix 30 can be a UV cureable resin or a thermosetting resin. The light scattering particles 334 have particle sizes in a range from 0.1 μm to 200 μm. The light diffusion layer 33 has a light output top surface 330 serving as a light output surface for the light guide member 100, and the light output top surface 330 has a plurality of netted dots 336 for diffusing light.

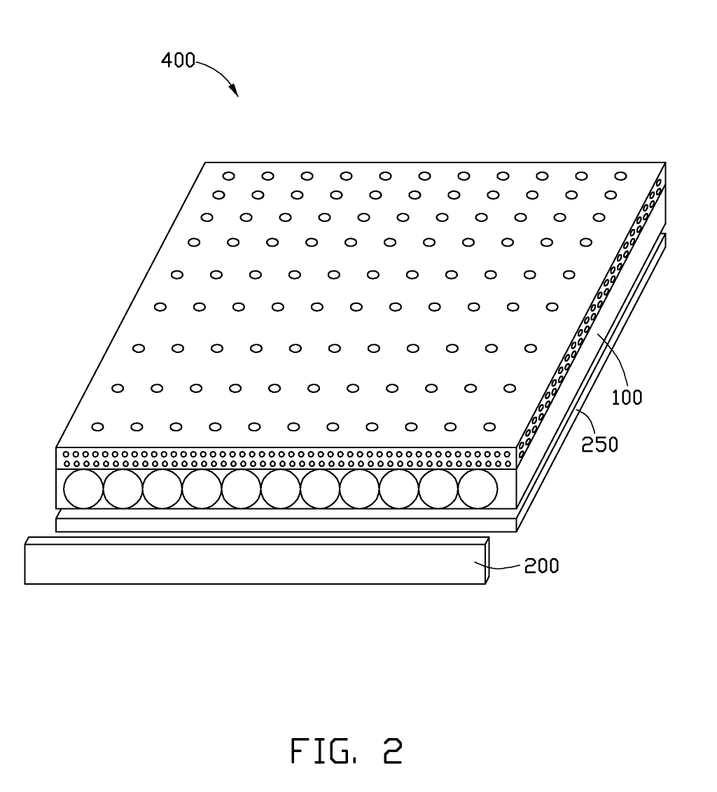

Referring to FIG. 2, in a backlight module 400, one or more light sources 200, such as LEDs are positioned in front of the light incident side surface 110 of the light guide member 100. Light emitted from the LEDs 200 enters the optical fibers 10. The optical fibers 10 can guide the light to reach all over the optical fibers layer 31 by reflection. A part of light which is not at a condition of total reflection in the optical fibers 10 transmits through the wall of the optical fibers 10 to reach at the light diffusion layer 33, and finally outputs from the light output top surface 330 of the light diffusion layer 33.

In order to break a total reflection in the optical fibers 10, an incident angle of the light can be predetermined, such that light guided by the optical fibers 10 can transmits through the wall of the optical fibers 10 to reach at the light diffusion layer 33. Furthermore, in order to reduce reflection in the optical fibers 10, a material with a smaller reflection index is preferred for making the optical fibers 10, and in addition, in order to avoid a total reflection at an interface between the optical fibers 10 and the matrix 332, a refraction index of the matrix 332 can be greater than that of the material of the optical fibers 10. The light scattering particles 334 can help scatter the light in the light diffusion layer 33, and the netted dots 336 help diffuse the light to be even at the light output top surface 330 of the light diffusion layer 33.

By the configuration of the optical fiber layer 31 and the light diffusion layer 33, the light guide member 100 has integrated the functions of conventional light guide plate and light diffusion plate. The optical fibers 10 are small in size, such that the entire light guide member 100 is thin.

In application, a reflection plate 250 may be placed under the light guide member 100 to reflect light which transmits through a bottom of the optical fiber layer 31 back to the optical fiber layer 31.

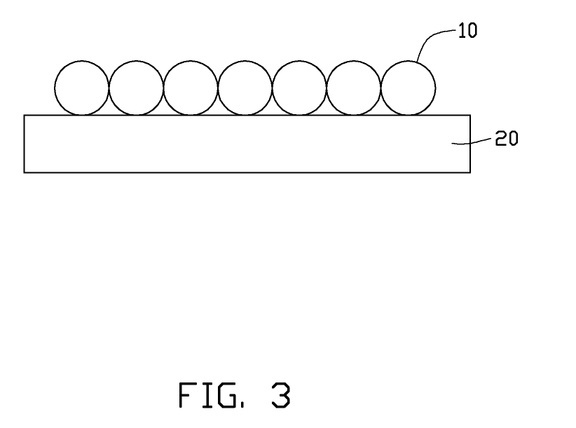

Referring to FIGS. 3-7, a method for making the light guide member 100 may include the following steps.

First, see FIG. 3, a supporter 20 is provided, and a number of optical fibers 10 are placed on the supporter 20. The optical fibers 10 can be made of plastic or glass, and are arranged parallel to each other.

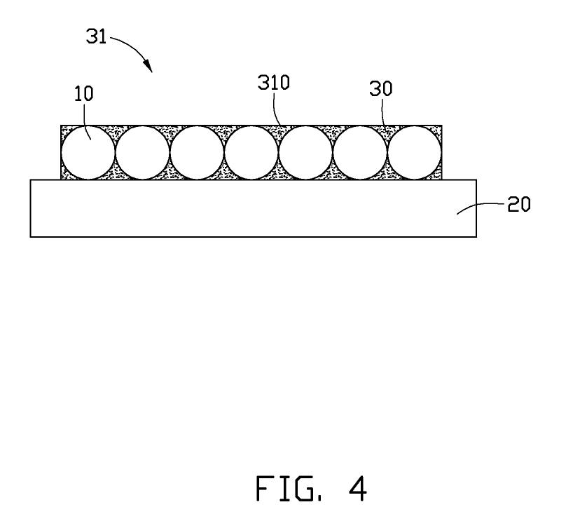

Second, see FIG. 4, a transparent matrix 30 is applied to the optical fibers 10 to adhere the optical fibers 10 in position.

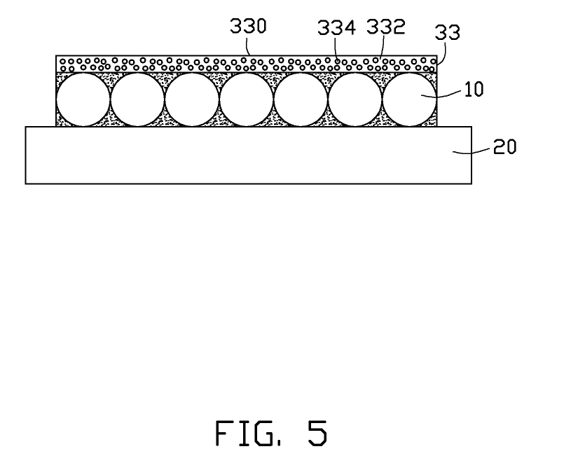

Third, see FIG. 5, a light diffusion layer 33 is formed on the optical fiber layer 31. The light diffusion layer 33 includes a transparent matrix 332 and a plurality of light scattering particles 334 dispersed in the matrix 332. The light diffusion layer 33 has a light output top surface 330.

Fourth, polishing the light output top surface 330 of the light diffusion layer 33 after the light diffusion layer 33 is dried.

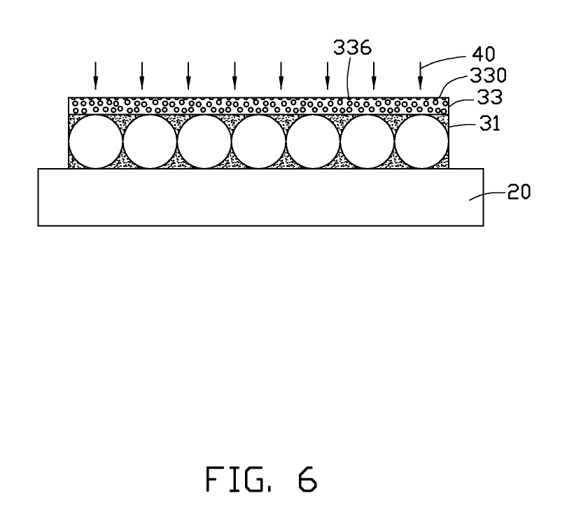

Fifth, see FIG. 6, the light output top surface 330 is machined by laser light 40 to form netted dots 336 on the light output top surface 330. In the present embodiment, the netted dots 336 are in concave shapes. In other embodiments, the netted dots 336 may be in a desired pattern according to need.

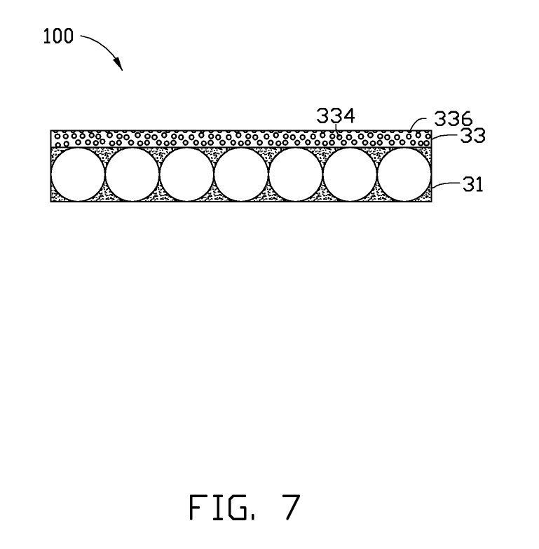

Finally, see FIG. 7, after removing the supporter 20, the light guide member 100 is obtained.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A light guide member, comprising:
an optical fiber layer comprising a first transparent matrix and a plurality of optical fibers arranged parallel with each other and adhered in position by the first transparent matrix, the optical fiber layer having a light incident side surface, and distal ends of the optical fibers exposed at the light incident side surface; and
a light diffusion layer formed on the optical fiber layer, the light diffusion layer comprising a second transparent matrix and a plurality of light scattering particles dispersed in the second transparent matrix, the light diffusion layer having a light output top surface, and the light output top surface having a plurality of netted dots configured for diffusing light.

2. The light guide member of claim 1, wherein each of the light scattering particles is in a size ranging from 0.1 μm to 200 μm.

3. The light guide member of claim 1, wherein the light output top surface is substantially perpendicular to the light incident side surface.

4. The light guide member of claim 1, wherein a material of the first transparent matrix is the same as a material of the second transparent matrix.

5. The light guide member of claim 1, wherein a refraction index of the second transparent matrix is greater than a refraction index of a wall of each of the optical fibers.

6. A backlight module, comprising:
a light source; and
a light guide member, comprising:
an optical fiber layer comprising a first transparent matrix and a plurality of optical fibers arranged parallel with each other and adhered in position by the first transparent matrix, the optical fiber layer having a light incident side surface, distal ends of the optical fibers exposed at the light incident side surface, and the light incident side surface facing toward the light source; and
a light diffusion layer formed on the optical fiber layer, the light diffusion layer comprising a second transparent matrix and a plurality of light scattering particles dispersed in the second transparent matrix, the light diffusion layer having a light output top surface, and the light output top surface having a plurality of netted dots configured for diffusing light, distal ends of the optical fibers configured for receiving light emitted from the light source, the optical fibers configured for emitting the light through a wall thereof such that the light passes through the light diffusion layer and exits from the light output top surface.

7. The backlight module of claim 6, wherein each of the light scattering particles is in a size ranging from 0.1 μm to 200 μm.

8. The backlight module of claim 6, wherein a material of the first transparent matrix is the same as a material of the second transparent matrix.

9. The backlight module of claim 6, wherein a refraction index of the second transparent matrix is greater than a refraction index of the wall of each of the optical fibers.

10. The backlight module of claim 6, further comprising a reflection plate located on an underside of the light guide member.

11. A method for making a light guide member, comprising:
providing a supporter;
arranging a plurality of parallel optical fibers on the supporter;
applying a first transparent matrix to the optical fibers to adhere the optical fibers in position, thereby forming an optical fiber layer;
forming a light diffusion layer on the optical fiber layer, the light diffusion layer comprising a second transparent matrix and a plurality of light scattering particles dispersed in the second transparent matrix;
polishing a top surface of the light diffusion layer;
forming a plurality of netted dots in the top surface after the top surface is polished; and
removing the supporter to obtain the light guide member comprising the optical fiber layer and the light diffusion layer.

12. The method of claim 11, wherein each of the light scattering particles is in a size ranging from 0.1 μm to 200 μm.

13. The method of claim 11, wherein a material of the first transparent matrix is the same as a material of the second transparent matrix.

14. The method of claim 11, wherein a refraction index of the second transparent matrix is greater than a refraction index of a wall of each of the optical fibers.
